(19) United States
(12) Patent Application Publication
(10) Pub. No.: US 2024/0021883 A1
(43) Pub. Date: Jan. 18, 2024

(54) Bipolar Storage Battery

(71) Applicants: The Furukawa Battery Co., Ltd., Yokohama (JP); Furukawa Electric Co., Ltd., Tokyo (JP)

(72) Inventors: Hideaki Yoshida, Nikko (JP); Satoshi Shibata, Iwaki (JP); Ryo Tainaka, Iwaki (JP); Naoki Nakakita, Iwaki (JP)

(21) Appl. No.: 18/473,929

(22) Filed: Sep. 25, 2023

Related U.S. Application Data
(63) Continuation of application No. PCT/JP2021/041426, filed on Nov. 10, 2021.

(30) Foreign Application Priority Data
Mar. 26, 2021 (JP) 2021-053770

(51) Int. Cl. H01M 10/12; H01M 10/18; H01M 50/51; H01M 4/66; H01M 4/68; H01M 50/503

(52) U.S. Cl. CPC H01M 10/12; H01M 10/18; H01M 50/51; H01M 4/661; H01M 4/68; H01M 50/503

(57) ABSTRACT

During welding for manufacturing a bipolar storage battery, it is possible to reduce heat accumulation inside an electrical conductor and heat conductivity to a periphery of a through-hole by connecting current collector plates on both surfaces of a substrate. In the battery in which a positive electrode current collector plate and a negative electrode current collector plate of cell members adjacent to each other are electrically connected to each other by an electrical conductor arranged in a through-hole and a plurality of cell members are electrically connected in series, an area of at least one of a connection surface of the electrical conductor with the positive electrode current conductor plate and a connection surface of the electrical conductor with the negative electrode current collector plate is smaller than a cross-sectional area of the electrical conductor parallel to the connection surface in a middle portion in a plate thickness direction.

### CROSS-REFERENCE TO RELATED APPLICATION(S)

This application is a continuation of PCT Application No. PCT/JP2021/041426, filed Nov. 10, 2021, the disclosure of which is incorporated herein in its entirety by reference.

### TECHNICAL FIELD

The present invention relates to a bipolar storage battery.

### BACKGROUND

In recent years, power generation facilities using natural energy such as sunlight and wind power have increased. In such power generation facilities, since the power generation amount cannot be controlled, the power load is leveled by using a storage battery. That is, when the amount of power generation is larger than a consumption, a difference is charged into the storage battery, and when the amount of power generation is smaller than a consumption, a difference is discharged from the storage battery. As the storage battery described above, a lead-acid storage battery is frequently used from the viewpoint of economic efficiency, safety, and the like. As such a conventional lead-acid storage battery, for example, a bipolar lead-acid storage battery described in JP Patent Publication No. 6124894 B2 is known.

The bipolar lead-acid storage battery has a frame shape and has a resin substrate attached to the inside of a resin frame. Lead layers are arranged on both surfaces of the substrate. A positive active material layer is adjacent to the lead layer formed on one surface of the substrate, and a negative active material layer is adjacent to the lead layer formed on the other surface of the substrate. In addition, a resin spacer having a frame shape is provided, and a glass mat impregnated with an electrolytic solution is arranged inside the spacer. A plurality of frames and spacers are alternately stacked, and the frames and the spacers are bonded to each other with an adhesive or the like.

In addition, the lead layers formed on both surfaces of the substrate are connected via a through-hole provided in the substrate. Paragraph number [0028] of JP Patent Publication No. 6124894 B2 describes that this connection is performed by, for example, resistance welding.

That is, the bipolar lead-acid storage battery described in JP Patent Publication No. 6124894 B2 includes a plurality of cell members each including a positive electrode including a positive electrode current collector plate (lead layer) and a positive active material layer, a negative electrode including a negative electrode current collector plate (lead layer) and a negative active material layer, and a separator (glass mat) interposed between the positive electrode and the negative electrode, the plurality of cell members being arranged in a stack manner with intervals; and a plurality of space forming members each forming a plurality of spaces for individually housing the plurality of cell members. In addition, the space forming member includes a substrate that covers at least one of a side of the positive electrode and a side of the negative electrode of the cell member, and a frame body (a frame portion and a spacer of a bipolar plate and an end plate) that surrounds a side surface of the cell member.

Further, the cell member and the substrate of the space forming member are arranged to be alternately stacked, the frame bodies are joined to each other, the substrate arranged between the cell members has a through-hole extending in a direction intersecting with a plate surface, the positive electrode current collector plate and the negative electrode current collector plate of the cell members adjacent to each other are electrically connected to each other by an electrical conductor arranged in the through-hole, and the plurality of cell members are electrically connected in series.

### SUMMARY

When a method of connecting the lead layers formed on both surfaces of the substrate by resistance welding via the through-hole of the substrate is adopted in manufacturing such a bipolar lead-acid storage battery, the lead layers are melted with a large current, and thus there are problems that heat is transferred to the surroundings and the resin substrate has a high temperature and that heat is accumulated inside the electrical conductor. Specifically, when the resin substrate is heated to a high temperature, the substrate may be softened and the sealability between cells may be deteriorated, and when heat is accumulated inside the electrical conductor, gas accumulation called a blow hole is likely to occur. When gas accumulation occurs, resistance between cells increases, which may adversely affect battery performance. In addition, during use of the bipolar lead-acid storage battery, the electrolytic solution may infiltrate into the gas accumulation and corrosion may progress. Furthermore, it is considered that such a problem also occurs in a case where the positive electrode current collector plate and the negative electrode current collector plate are formed of a metal layer (metal foil) other than a lead layer (lead foil).

An object of the present invention is to reduce heat accumulation inside an electrical conductor and to reduce heat conductivity to a periphery of a through-hole during welding when a bipolar storage battery is manufactured through a welding step of connecting current collector plates formed on both surfaces of a substrate by resistance welding or the like via the electrical conductor arranged in the through-hole of the substrate.

In order to solve the problems described above, one aspect of the present invention is a bipolar storage battery having the following configurations (1) to (4).

(1) A bipolar storage battery includes a plurality of cell members each including a positive electrode including a positive electrode current collector plate and a positive active material layer, a negative electrode including a negative electrode current collector plate and a negative active material layer, and a separator interposed between the positive electrode and the negative electrode, the plurality of cell members being arranged in a stack manner with intervals; and a plurality of space forming members each forming a plurality of spaces for individually housing the plurality of cell members.

(2) The space forming member includes a substrate that covers at least one of a side of the positive electrode and a side of the negative electrode of the cell member, and a frame body that surrounds a side surface of the cell member. The cell member and the substrate of the space forming member are arranged to be alternately stacked. The frame bodies are joined to each other.

(3) The substrate arranged between the cell members has a through-hole extending in a direction intersecting with a plate surface. The positive electrode current collector plate and the negative electrode current collector plate of the cell members adjacent to each other are electrically connected to each other by an electrical conductor arranged in the through-hole, and the plurality of cell members are electrically connected in series.

(4) An area of at least one of a connection surface of the electrical conductor with the positive electrode current collector plate and a connection surface of the electrical conductor with the negative electrode current collector plate is smaller than a cross-sectional area of the electrical conductor parallel to the connection surface in a middle portion in a plate thickness direction of the substrate.

According to the present invention, it is possible to reduce heat accumulation inside an electrical conductor and to reduce heat conductivity to a periphery of a through-hole during welding when a bipolar storage battery is manufactured through a welding step of connecting current collector plates formed on both surfaces of a substrate by resistance welding or the like via the electrical conductor arranged in the through-hole of the substrate.

### BRIEF DESCRIPTION OF THE DRAWINGS

FIG. 1 is a cross-sectional view illustrating a schematic configuration of a bipolar lead-acid storage battery according to an embodiment of the present invention.

FIG. 2 is a partially enlarged view of the bipolar lead-acid storage battery of FIG. 1.

FIG. 3 is a perspective view illustrating a stacked and coupled state of space forming members constituting the bipolar lead-acid storage battery of FIG. 1.

FIG. 4 is a plan view illustrating an example of a substrate of a biplate.

FIG. 5 is a partially enlarged view illustrating an electrical conductor and a peripheral portion thereof in the bipolar lead-acid storage battery of FIG. 1.

### DETAILED DESCRIPTION

Hereinafter, embodiments of the present invention will be described, but the present invention is not limited to the following embodiments. In the embodiments described below, technically preferable limitations are made to implement the present invention, but this limitation is not an essential requirement of the present invention. Note that, hereinafter, explanation will be given using a lead-acid storage battery as an example among various storage batteries.

Overall Configuration

First, an overall configuration of a bipolar lead-acid storage battery of the embodiment will be described.

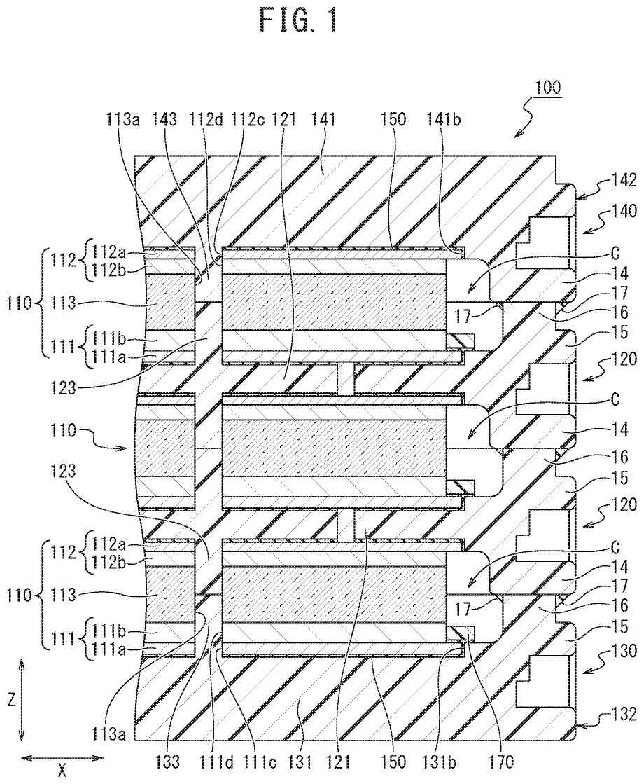

As illustrated in FIG. 1, a bipolar lead-acid storage battery 100 of the embodiment includes a plurality of cell members 110, a plurality of biplates 120 (space forming members), a first end plate 130 (space forming member), a second end plate 140 (space forming member), and a cover plate 170. FIG. 1 illustrates the bipolar lead-acid storage battery 100 in which three cell members 110 are stacked, but the number of cell members 110 is determined by battery design. In addition, the number of the biplates 120 is determined according to the number of the cell members 110.

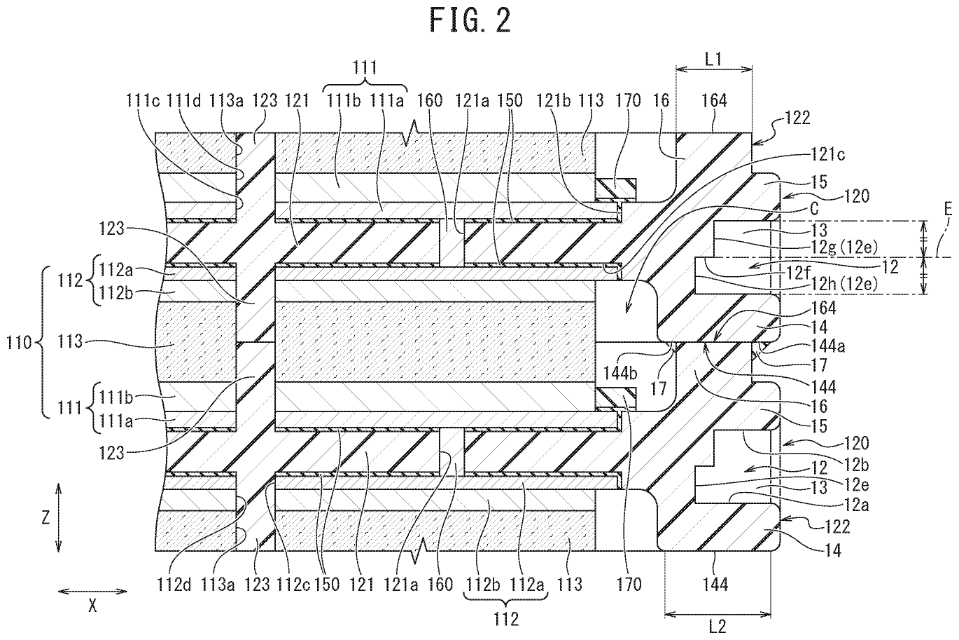

FIG. 2 is a view illustrating two biplates 120 extracted from FIG. 1.

As illustrated in FIGS. 1 to 3, a stacking direction of the cell members 110 is defined as a Z direction (vertical direction in FIGS. 1 to 3), and directions perpendicular to the Z direction and perpendicular to each other are defined as an X direction and a Y direction.

The cell member 110 includes a positive electrode 111, a negative electrode 112, and a separator 113 (electrolyte layer). The separator 113 is impregnated with an electrolytic solution. The positive electrode 111 includes a positive electrode lead foil 111a (positive electrode current collector plate) and a positive active material layer 111b. The negative electrode 112 includes a negative electrode lead foil 112a (negative electrode current collector plate) and a negative active material layer 112b. The separator 113 is interposed between the positive electrode 111 and the negative electrode 112. In the cell member 110, the positive electrode lead foil 111a, the positive active material layer 111b, the separator 113, the negative active material layer 112b, and the negative electrode lead foil 112a are stacked in this order.

Dimensions of the positive electrode lead foil 111a and the negative electrode lead foil 112a in the X direction and the Y direction are larger than dimensions of the positive active material layer 111b and the negative active material layer 112b in the X direction and the Y direction. A dimension (thickness) in the Z direction is larger (thicker) in the positive electrode lead foil 111a than in the negative electrode lead foil 112a, and is larger (thicker) in the positive active material layer 111b than in the negative active material layer 112b.

The plurality of cell members 110 are arranged in a stack manner with intervals in the Z direction, and a substrate 121 of the biplate 120 is arranged at the interval. That is, the plurality of cell members 110 are stacked with the substrate 121 of the biplate 120 interposed therebetween.

The plurality of biplates 120, the first end plate 130, and the second end plate 140 are members for forming a plurality of spaces C (cells) for individually housing the plurality of cell members 110.

As illustrated in FIG. 2, the biplate 120 includes a substrate 121 having a rectangular planar shape, a frame body 122 covering four end surfaces of the substrate 121, and column portions 123 vertically protruding from both surfaces of the substrate 121, and the substrate 121, the frame body 122, and the column portions 123 are integrally formed of a synthetic resin. Note that the number of column portions 123 protruding from each surface of the substrate 121 may be one or plural.

In the Z direction, a dimension of the frame body 122 is larger than a dimension (thickness) of the substrate 121, and a dimension between protruding end surfaces of the column portions 123 is the same as the dimension of the frame body 122. A space C is formed between the substrate 121 and the substrate 121 by stacking the plurality of biplates 120 in contact with the frame body 122 and the column portions 123, and a dimension of the space C in the Z direction is maintained by the column portions 123 that are in contact with each other.

Through-holes 111c, 111d, 112c, 112d, and 113a penetrating the column portion 123 are formed in the positive electrode lead foil 111a, the positive active material layer 111b, the negative electrode lead foil 112a, the negative active material layer 112b, and the separator 113, respectively.

The substrate 121 of the biplate 120 has a plurality of through-holes 121a extending perpendicular to the plate surface (in a direction intersecting with the plate surface). In addition, a first recess 121b is formed on one surface of the substrate 121, and a second recess 121c is formed on the other surface of the substrate 121. A depth of the first recess 121b is deeper than a depth of the second recess 121c. Dimensions of the first recess 121b and the second recess 121c in the X direction and the Y direction correspond to the dimensions of the positive electrode lead foil 111a and the negative electrode lead foil 112a in the X direction and the Y direction.

The substrate 121 of the biplate 120 is arranged between the cell members 110 adjacent to each other in the Z direction.

The positive electrode lead foil 111a of the cell member 110 is arranged in the first recess 121b of the substrate 121 of the biplate 120 with an adhesive layer 150 interposed therebetween.

The cover plate 170 is for covering an outer edge of the positive electrode lead foil 111a, is a thin plate-shaped frame body, and has a rectangular inner shape line and outer shape line. An inner edge of the cover plate 170 overlaps the outer edge of the positive electrode lead foil 111a, and an outer edge of the cover plate 170 overlaps a peripheral edge of the first recess 121b formed on one surface of the substrate 121. That is, the rectangle forming the inner shape line of the cover plate 170 is smaller than the rectangle forming the outer shape line of the positive active material layer 111b, and the rectangle forming the outer shape line of the cover plate 170 is larger than the rectangle forming an opening surface of the first recess 121b.

The adhesive layer 150 extends from the end surface of the positive electrode lead foil 111a to the outer edge of the first recess 121b on the opening side, is also arranged between the inner edge of the cover plate 170 and the outer edge of the positive electrode lead foil 111a, and is also arranged between the outer edge of the cover plate 170 and one surface of the substrate 121. That is, the cover plate 170 is fixed by the adhesive layer 150 over the peripheral edge of the first recess 121b formed on one surface of the substrate 121 and the outer edge of the positive electrode lead foil 111a. Thus, the outer edge of the positive electrode lead foil 111a is reliably covered with the cover plate 170 even at a boundary portion with the peripheral edge of the first recess 121b.

In addition, the negative electrode lead foil 112a of the cell member 110 is arranged in the second recess 121c of the substrate 121 of the biplate 120 with the adhesive layer 150 interposed therebetween. Note that the outer edge of the negative electrode lead foil 112a may also be covered with a cover plate similar to the cover plate 170 covering the outer edge of the positive electrode lead foil 111a.

An electrical conductor 160 is arranged in the through-hole 121a of the substrate 121 of the biplate 120, and both end surfaces of the electrical conductor 160 are in contact with and coupled to the positive electrode lead foil 111a and the negative electrode lead foil 112a. That is, the positive electrode lead foil 111a and the negative electrode lead foil 112a are electrically connected by the electrical conductor 160. As a result, all of the plurality of cell members 110 are electrically connected in series.

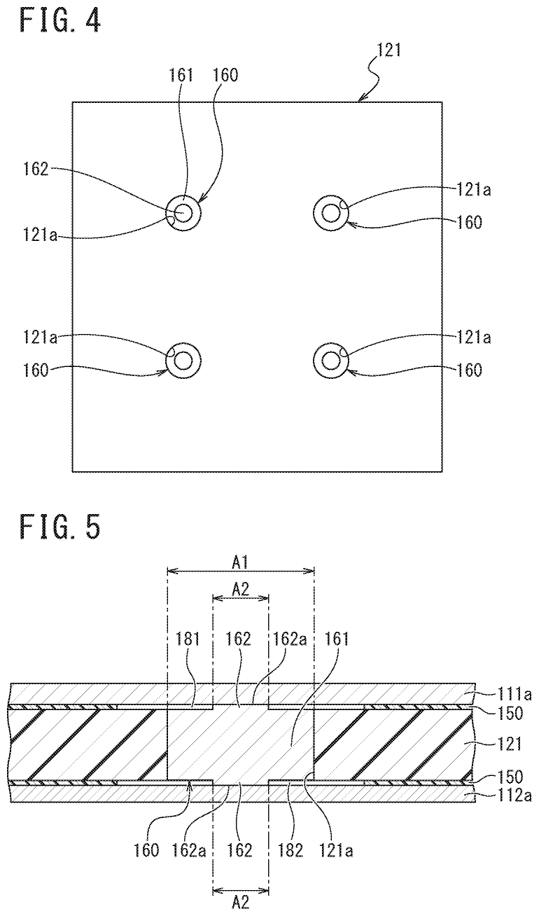

For example, as illustrated in FIGS. 4 and 5, the substrate 121 of the biplate 120 has a plurality of cylindrical through-holes 121a, and the electrical conductor 160 is embedded in each of the through-holes 121a. The electrical conductor 160 illustrated in FIGS. 4 and 5 includes a disk-shaped large-diameter portion 161 (middle portion) and a pair of disk-shaped small-diameter portions 162 (end portions) integrally formed at ends of the large-diameter portion 161 in an axial direction. A thickness of the disk constituting the small-diameter portion 162 is smaller than a thickness of the disk constituting the large-diameter portion 161. The small-diameter portion 162 has a joint surface 162a with the positive electrode lead foil 111a and the negative electrode lead foil 112a. The adhesive layer 150 is not present near the through-hole 121a.

A space 181 surrounded by the electrical conductor 160, the positive electrode lead foil 111a, the through-hole 121a, and the adhesive layer 150 is formed on a side of the positive electrode lead foil 111a in the plate thickness direction of the substrate 121. A space 182 surrounded by the electrical conductor 160, the negative electrode lead foil 112a, the through-hole 121a, and the adhesive layer 150 is formed on a side of the negative electrode lead foil 112a in the plate thickness direction of the substrate 121.

A diameter A1 of the large-diameter portion 161 is slightly smaller than a diameter of the through-hole 121a, and a ratio (A2/A1) of a diameter A2 of the small-diameter portion 162 to the diameter A1 of the large-diameter portion 161 is, for example, 2/5.

In addition, a ratio (S2/S1) of an area S2 of the connection surface 162a of the small-diameter portion 162 with the positive electrode lead foil 111a and the negative electrode lead foil 112a to a cross-sectional area S1 of the large-diameter portion 161 parallel to the connection surface 162a is 0.01 or more and 0.50 or less. The ratio (S2/S1) is preferably 0.03 or more and 0.30 or less.

As illustrated in FIG. 1, the first end plate 130 includes a substrate 131 that covers a side of the positive electrode of the cell member 110, a frame body 132 that surrounds the side surface of the cell member 110, and a column portion 133 that vertically protrudes from one surface of the substrate 131 (a surface of the biplate 120 arranged closest to the side of the positive electrode, the surface facing the substrate 121). A planar shape of the substrate 131 is rectangular, four end surfaces of the substrate 131 are covered with the frame body 132, and the substrate 131, the frame body 132, and the column portion 133 are integrally formed of a synthetic resin. Note that the number of column portions 133 protruding from one surface of the substrate 131 may be one or plural but corresponds to the column portion 123 of the biplate 120 to be brought into contact with the column portion 133.

In the Z direction, a dimension of the frame body 132 is larger than a dimension (thickness) of the substrate 131, and a dimension between protruding end surfaces of the column portion 133 is the same as the dimension of the frame body 132. A space C is formed between the substrate 121 of the biplate 120 and the substrate 131 of the first end plate 130 by stacking the frame body 132 and the column portion 133 in contact with the frame body 122 and the column portion 123 of the biplate 120 arranged on the outermost side (positive electrode side), and a dimension of the space C in the Z direction is maintained by the column portion 123 of the biplate 120 and the column portion 133 of the first end plate 130, which are in contact with each other.

Through-holes 111c, 111d, and 113a penetrating the column portion 133 are formed in the positive electrode lead foil 111a, the positive active material layer 111b, and the separator 113 of the cell member 110 arranged on the outermost side (positive electrode side), respectively.

A recess 131b is formed on one surface of the substrate 131 of the first end plate 130. A dimension of the recess 131b in the X direction and the Y direction corresponds to the dimension of the positive electrode lead foil 111a in the X direction and the Y direction.

The positive electrode lead foil 111a of the cell member 110 is arranged in the recess 131b of the substrate 131 of the first end plate 130 with the adhesive layer 150 interposed therebetween. In addition, similarly to the substrate 121 of the biplate 120, the cover plate 170 is fixed to one surface of the substrate 131 by the adhesive layer 150, and the outer edge of the positive electrode lead foil 111a is reliably covered with the cover plate 170 even at a boundary portion with a peripheral edge of the recess 131b.

In addition, the first end plate 130 includes a positive electrode terminal electrically connected to the positive electrode lead foil 111a in the recess 131b.

The second end plate 140 includes a substrate 141 that covers the negative electrode of the cell member 110, a frame body 142 that surrounds the side surface of the cell member 110, and a column portion 143 that vertically protrudes from one surface of the substrate 141 (a surface of the biplate 120 arranged closest to the negative electrode, the surface facing the substrate 121). A planar shape of the substrate 141 is rectangular, four end surfaces of the substrate 141 are covered with the frame body 142, and the substrate 141, the frame body 142, and the column portion 143 are integrally formed of a synthetic resin. Note that the number of column portions 143 protruding from one surface of the substrate 141 may be one or plural but corresponds to the column portion 123 of the biplate 120 to be brought into contact with the column portion 143.

In the Z direction, a dimension of the frame body 142 is larger than a dimension (thickness) of the substrate 131, and a dimension between two protruding end surfaces of the column portion 143 is the same as the dimension of the frame body 142. A space C is formed between the substrate 121 of the biplate 120 and the substrate 141 of the second end plate 140 by stacking the frame body 142 and the column portion 143 in contact with the frame body 122 and the column portion 123 of the biplate 120 arranged on the outermost side (negative electrode side), and a dimension of the space C in the Z direction is maintained by the column portion 123 of the biplate 120 and the column portion 143 of the second end plate 140, which are in contact with each other.

Through-holes 112c, 112d, and 113a penetrating the column portion 143 are formed in the negative electrode lead foil 112a, the negative active material layer 112b, and the separator 113 of the cell member 110 arranged on the outermost side (negative electrode side), respectively.

A recess 141b is formed on one surface of the substrate 141 of the second end plate 140. A dimension of the recess 141b in the X direction and the Y direction corresponds to a dimension of the negative electrode lead foil 112a in the X direction and the Y direction.

The negative electrode lead foil 112a of the cell member 110 is arranged in the recess 141b of the substrate 141 of the second end plate 140 with the adhesive layer 150 interposed therebetween.

In addition, the second end plate 140 includes a negative electrode terminal electrically connected to the negative electrode lead foil 112a in the recess 141b.

The biplate 120, the first end plate 130, the second end plate 140, and the cover plate 170 are formed of a resin, for example, a thermoplastic resin. As the thermoplastic resin, for example, an acrylonitrile-butadiene-styrene copolymer (ABS resin) and polypropylene can be used. These thermoplastic resins are excellent in moldability and also excellent in sulfuric acid resistance. Therefore, the components are formed of these thermoplastic resins, such that decomposition, deterioration, corrosion, and the like associated with the contact of the electrolytic solution are less likely to occur in the biplate 120, the first end plate 130, the second end plate 140, and the cover plate 170.

Note that, as can be seen from the above description, the biplate 120 is a space forming member including the substrate 121 that covers both a side of the positive electrode and a side of the negative electrode of the cell member 110 and the frame body 122 that surrounds the side surface of the cell member 110. The first end plate 130 is a space forming member including the substrate 131 that covers the side of the positive electrode of the cell member 110 and the frame body 132 that surrounds the side surface of the cell member 110. The second end plate 140 is a space forming member including the substrate 141 that covers the negative electrode of the cell member 110 and the frame body 142 that surrounds the side surface of the cell member 110.

Frame Bodies of Biplate and First and Second End Plates

Hereinafter, when a configuration common to the frame body 122 of the biplate 120, the frame body 132 of the first end plate, and the frame body 142 of the second end plate is described, these frame bodies 122, 132, and 142 will be simply described as a “frame body”.

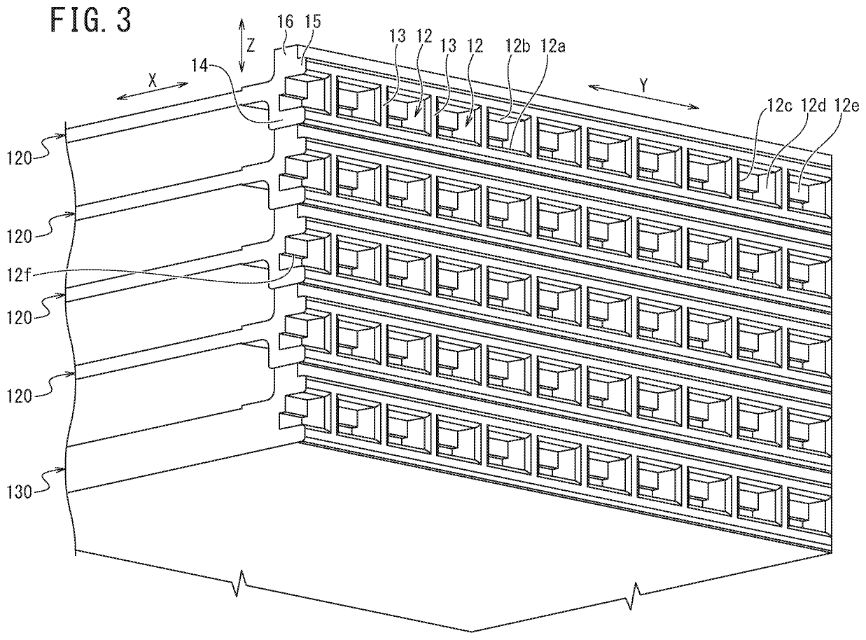

As illustrated in FIGS. 1 to 3, a large number of recesses 12 are formed on four end surfaces (an outer surface, FIG. 3 illustrates one end surface in the X direction) of the frame body. The recess 12 has one surface 12a and the other surface 12b facing each other in the Z direction, one surface 12c and the other surface 12d facing each other in the X direction or the Y direction, and a non-flat bottom surface 12e.

That is, the frame body includes a wall portion 13 that partitions the recesses 12 adjacent to each other, a first plate portion 14 that continuously forms the one surfaces 12a of the large number of recesses 12 facing each other in the Z direction, a second plate portion 15 that continuously forms the Z direction and the other surfaces 12b of the plurality of recesses 12, and a leg portion 16 that extends from the second plate portion 15 to a side opposite to the first plate portion 14 (the upper side in FIGS. 1 to 3).

A surface of the first plate portion 14 opposite to the second plate portion 15 (lower side in FIGS. 1 to 3) are chamfered at both ends in the X direction, and a dimension L2 of a surface 144 (the other facing surface) in the X direction excluding the chamfered portion is larger than a dimension L1 of a surface 164 (one facing surface) of the leg portion 16 opposite to the second plate portion 15 (upper side in FIGS. 1 to 3) in the X direction. Regarding a relationship between both dimensions, the ratio (L2/L1) is preferably 5/4 or more and 2 or less, and the ratio (L2/L1) is more preferably 3/2 (that is, L1:L2=2:3). For example, L1 is 4 mm, and L2 is 6 mm.

In addition, the bottom surface 12e has a step, and a surface 12f along the step exists at the middle position of the recess 12 in the Z direction (the stacking direction of the cell member 110). The line E in FIG. 2 is a line indicating a position of the surface 12f along the step in the Z direction. That is, the bottom surface 12e has a first bottom surface 12g and a second bottom surface 12h having the same area and different depths. A depth (dimension in the X direction) of the first bottom surface 12g, which is a bottom surface on the positive electrode 111 of the biplate 120, is shallower than a depth of the second bottom surface 12h, which is a bottom surface on the negative electrode 112 of the biplate 120.

The bipolar lead-acid storage battery 100 has a joint structure by vibration welding between the facing surfaces of the frame bodies, and in the joint structure, a surface 164 of the leg portion 16 and a surface 144 of the first plate portion 14, which are the facing surfaces of the frame bodies, are directly joined by vibration welding. In addition, the entire surface of the surface 164 (one facing surface) of the leg portion 16 is a contact surface, and the surface 144 (the other facing surface) of the first plate portion 14 has non-contact surfaces 144a and 144b that are not in contact with the surface 164 of the leg portion 16 on the outer side and the inner side of the surface 164 of the leg portion 16 in a direction along the substrate surface (the X direction in the cross section illustrated in FIGS. 1 to 3). Furthermore, a reinforcing portion 17 exists at a corner portion formed by the non-contact surfaces 144a and 144b of the first plate portion 14 that are not in contact with the surface 164 of the leg portion 16 and an outer surface and an inner surface of the leg portion 16.

Note that one end surface of the four end surfaces of the frame body is provided with a cutout portion forming an injection hole for filling the space C with an electrolytic solution. For example, in a case where the cutout portion is formed on a side surface of the frame body existing on the right side in FIG. 1, the cutout portion has a shape that penetrates the frame body in the X direction and is recessed in a semicircular arc shape from both end surfaces of the frame body in the Z direction. The cutout portion is not involved in the joint structure described above, and when the joint structure described above is formed by vibration welding, a circular injection hole is formed by the facing cutout portions.

Manufacturing Method

The bipolar lead-acid storage battery 100 of the embodiment can be manufactured by a method including the following steps.

Step of Preparing Biplate with Lead Foil for Positive or Negative Electrode

First, the substrate 121 of the biplate 120 is placed on a workbench so that the first recess 121b faces upward, an adhesive is applied to the first recess 121b, and the positive electrode lead foil 111a is placed in the first recess 121b. At this time, the column portion 123 of the biplate 120 is set to pass through the through-hole 111c of the positive electrode lead foil 111a. The adhesive is cured, and the positive electrode lead foil 111a is attached to one surface of the substrate 121.

Next, the substrate 121 is placed on the workbench so that the second recess 121c faces upward, and the electrical conductor 160 is inserted into the through-hole 121a. Next, an adhesive is applied to the second recess 121c, and the negative electrode lead foil 112a is placed in the second recess 121c. At this time, the column portion 123 of the biplate 120 is set to pass through the through-hole 112c of the negative electrode lead foil 112a. The adhesive is cured, and the negative electrode lead foil 112a is attached to the other surface of the substrate 121.

Next, the substrate 121 is placed on a workbench so that the first recess 121b faces upward, an adhesive is applied onto the outer edge of the positive electrode lead foil 111a and the upper surface of the substrate 121 serving as the edge of the first recess 121b, the cover plate 170 is placed thereon, and the adhesive is cured. Therefore, the cover plate 170 is fixed over the outer edge of the positive electrode lead foil 111a and the portion of the substrate 121 (the peripheral edge of the first recess 121b) that continues to the outside thereof. A dimension (L3) of the portion arranged on the outer edge of the positive electrode lead foil 111a is larger than a dimension (L4) of the portion arranged on the portion of the substrate 121 that continues to the outside (for example, L3:L4=5:4).

Next, resistance welding is performed to connect the positive electrode lead foil 111a and the negative electrode lead foil 112a with the electrical conductor 160. The resistance welding is performed by applying a current to the entire contact surface between the small-diameter portion 162 and the positive electrode lead foil 111a and the negative electrode lead foil 112a. As a result, the entire contact surface is melted to form a connection surface.

Therefore, the biplate 120 with a lead foil for a positive or negative electrode is obtained. The required number of the biplates 120 with a lead foil for a positive or negative electrode are prepared.

Step of Preparing End Plate with Positive Electrode Lead Foil

The substrate 131 of the first end plate 130 is placed on a workbench so that the recess 131b faces upward, an adhesive is applied to the recess 131b, the positive electrode lead foil 111a is placed in the recess 131b, and the adhesive is cured. At this time, the column portion 133 of the end plate 130 is set to pass through the through-hole 111c of the positive electrode lead foil 111a. The adhesive is cured, and the positive electrode lead foil 111a is attached to one surface of the substrate 131.

Next, an adhesive is applied onto the outer edge of the positive electrode lead foil 111a and the upper surface of the substrate 131 serving as the edge of the recess 131b, the cover plate 170 is placed thereon, and the adhesive is cured. Therefore, the cover plate 170 is fixed over the outer edge of the positive electrode lead foil 111a and the portion of the substrate 131 that continues to the outside thereof. A dimension (L3) of the portion arranged on the outer edge of the positive electrode lead foil 111a is larger than a dimension (L4) of the portion arranged on the portion of the substrate 131 that continues to the outside (for example, L3:L4=5:4).

Therefore, an end plate with a positive electrode lead foil is obtained.

Step of Preparing End Plate with Negative Electrode Lead Foil

The substrate 141 of the second end plate 140 is placed on a workbench so that the recess 141b faces upward, an adhesive is applied to the recess 141b, the negative electrode lead foil 112a is placed in the recess 141b, and the adhesive is cured. At this time, the column portion 143 of the second end plate 140 is set to pass through the through-hole 112c of the negative electrode lead foil 112a. The adhesive is cured to obtain the second end plate 140 in which the negative electrode lead foil 112a is attached to one surface of the substrate 141.

Step of Stacking and Joining Plates

First, the first end plate 130 to which the positive electrode lead foil 111a and the cover plate 170 are fixed is placed on a workbench so that the positive electrode lead foil 111a faces upward, and the positive active material layer 111b is placed in the cover plate 170 and placed on the positive electrode lead foil 111a. At this time, the column portion 133 of the first end plate 130 is set to pass through the through-hole 111d of the positive active material layer 111b. Next, the separator 113 and the negative active material layer 112b are placed on the positive active material layer 111b.

Next, on the first end plate 130 in this state, the negative electrode lead foil 112a of the biplate 120 with a lead foil for a positive or negative electrode is placed downward. At this time, the column portion 123 of the biplate 120 is passed through the through-hole 113a of the separator 113 and the through-hole 112d of the negative active material layer 112b to be placed on the column portion 133 of the first end plate 130, and the first plate portion 14 of the frame body 122 of the biplate 120 is placed on the leg portion 16 of the frame body 132 of the first end plate 130.

In this state, the first end plate 130 is fixed, and vibration welding is performed while the biplate 120 is vibrated at an amplitude of 1.6 mm in a diagonal direction of the substrate 121. Therefore, the first plate portion 14 of the frame body 122 of the biplate 120 is joined onto the leg portion 16 of the frame body 132 of the first end plate 130, and the column portion 123 of the biplate 120 is joined onto the column portion 133 of the first end plate 130. As a result, the biplate 120 is joined onto the first end plate 130, the cell member 110 is disposed in the space C formed by the first end plate 130 and the biplate 120, and the positive electrode lead foil 111a is exposed on the upper surface of the biplate 120.

Next, after the positive active material layer 111b, the separator 113, and the negative active material layer 112b are placed in this order on the thus-obtained coupled body in which the biplate 120 is joined onto the first end plate 130, the biplate 120 with another lead foil for a positive or negative electrode is placed so that the negative electrode lead foil 112a faces downward. In this state, the coupled body is fixed, and vibration welding is performed while the biplate 120 with another lead foil for a positive or negative electrode is vibrated at an amplitude of 1.6 mm in the diagonal direction of the substrate 121. The vibration welding step is continued until the required number of biplates 120 are joined onto the first end plate 130.

Finally, after the positive active material layer 111b, the separator 113, and the negative active material layer 112b are placed in this order on the uppermost biplate 120 of the coupled body in which all the biplates 120 are joined, the second end plate 140 is placed so that the negative electrode lead foil 112a faces downward. In this state, the coupled body is fixed, and vibration welding is performed while the second end plate 140 is vibrated at an amplitude of 1.6 mm in the diagonal direction of the substrate 141. Therefore, the second end plate 140 is joined onto the uppermost biplate 120 of the coupled body in which all the biplates 120 are joined.

In addition, in the vibration welding step, the synthetic resin forming the first plate portion 14 and the leg portion 16 melts, and cools and solidifies in a state of moving between the non-contact surfaces 144a and 144b of the first plate portion 14 and the outer surface and the inner surface of the leg portion 16, such that the reinforcing portion 17 is formed at the corner portion formed by the non-contact surfaces 144a and 144b and the outer surface and the inner surface of the leg portion 16.

Step of Injecting Electrolytic Solution

In the step stacking and joining the plates described above, a joint structure is formed by vibration welding between facing surfaces of the frame bodies, and a circular injection hole is formed at a position of each space C on one end surface of the bipolar lead-acid storage battery 100 in the X direction, for example, by facing cutout portions of the frame body. An electrolytic solution is injected into each space C through the injection hole, and the separator 113 is impregnated with the electrolytic solution.

Note that as described above, the injection hole may be formed by providing the cutout portion in the frame body in advance or may be formed by using a drill or the like after joining the frame body.

Action and Effect

The bipolar lead-acid storage battery 100 of the embodiment has a joint structure (joint structure by direct joining) in which facing surfaces of frame bodies are joined by vibration welding, and in this joint structure, one facing surface 164 is a contact surface on the entire surface, and the other facing surface 144 has non-contact surfaces 144a and 144b outside and inside the one facing surface 164 in the X direction and the Y direction (direction along the substrate surface). In addition, L1 is 4 mm, L2 is 6 mm (that is, L2/L1=5/4 or more and 2 or less is satisfied), and vibration welding is performed while vibration is performed at an amplitude of 1.6 mm in the diagonal direction of the substrates 121 and 141, such that the facing surfaces of the frame bodies are in full contact with each other at all times during vibration welding.

Therefore, as compared with a bipolar lead-acid storage battery configured so that the facing surfaces of the frame bodies are not in full contact with each other at the time of vibration welding, the joining strength between the facing surfaces of the frame bodies is high. In addition, the presence of the reinforcing portion 17 increases the joining strength as compared with the case where the reinforcing portion 17 is not provided.

In the bipolar lead-acid storage battery 100 of the embodiment, because a surface area exposed to the outside air on the end surface of the frame body is increased by the large number of recesses 12 formed on the four end surfaces (outer surfaces) of the frame body, the heat dissipation is enhanced as compared with the bipolar lead-acid storage battery not provided with such recesses. In addition, because the bottom surface 12e of the recess 12 has a step, the surface area exposed to the outside air on the end surface of the frame body is increased as compared with the case where the bottom surface of the recess 12 is flat, such that the heat dissipation is further improved.

Furthermore, because the surface 12f along the step included in the bottom surface 12e of the recess 12 is present at the middle position in the Z direction of the recess 12, more effective heat dissipation is achieved at the position where the heat from the positive electrode 111 and the heat from the negative electrode 112 of the substrate 121 converge, as compared with the case where the surface 12f is present at a position shifted from the middle position of the recess 12 in the Z direction.

As a result, according to the bipolar lead-acid storage battery 100 of the embodiment, it is possible to prevent deterioration of battery performance due to heat accumulated inside.

Further, in a case where the recess is provided on the end surface of the frame body, the mechanical strength of the frame body against pressurization during vibration welding may be decreased. On the other hand, in the bipolar lead-acid storage battery 100 of the embodiment, the wall portion 13 extending in the Z direction formed by providing a large number of recesses 12 in the X direction and the Y direction reduces a decrease in mechanical strength of the frame body against pressurization during vibration welding, and deformation is suppressed. As a result, reliability of joining by vibration welding is increased.

Furthermore, because the outer edge of the positive electrode lead foil 111a is reliably covered with the cover plate 170 even at the boundary portion with the peripheral edge of the first recess 121b, even in a case where the positive electrode 111 is corroded by sulfuric acid in the electrolytic solution to cause growth, the electrolytic solution is suppressed from infiltrating into the end portion of the positive electrode lead foil 111a. As a result, because the “electrolytic solution infiltrates into an interface between the positive electrode lead foil 111a and the adhesive layer 150, and reaches the negative electrode lead foil 112a via a gap between the through-hole 121a of the substrate 121 and the electrical conductor 160” is suppressed, the bipolar lead-acid storage battery 100 of the embodiment also has an effect of preventing a short circuit and suppressing deterioration of battery performance.

In addition, the area S2 of the connection surface 162a of the electrical conductor 160 with the positive electrode lead foil 111a and the negative electrode lead foil 112a is smaller than the cross-sectional area S1 of the large-diameter portion 161 that is the middle portion (S1>S2), and resistance welding is performed by applying a current to the entire contact surface between the small-diameter portion 162 and the positive electrode lead foil 111a and the negative electrode lead foil 112a, such that the entire contact surface is dissolved to become the connection surface, and the surface of the large-diameter portion 161 on the positive electrode lead foil 111a and the surface of the large-diameter portion 161 on the negative electrode lead foil 112a are not dissolved.

On the other hand, in a case where resistance welding is performed by applying a current to the entire contact surface between the electrical conductor and the positive electrode lead foil 111a and the entire contact surface between the electrical conductor and the negative electrode lead foil 112a by using an electrical conductor made of a cylindrical body having a diameter of the through-hole 121a slightly larger than the diameter A2 of the small-diameter portion 162, and having the same diameter as that of the small-diameter portion 162 and the same dimension as that of the electrical conductor 160 in the axial direction (first case), the entire surface of the electrical conductor on the positive electrode lead foil 111a and the entire surface of the electrical conductor on the negative electrode lead foil 112a are melted to form a connection surface.

As compared with the first case, in the bipolar lead-acid storage battery 100 of the embodiment, only a part (small-diameter portion 162) of the surface of the electrical conductor 160 on the positive electrode lead foil 111a and a part (small-diameter portion 162) of the electrical conductor 160 on the negative electrode lead foil 112a are dissolved to form the connection surface, such that the volume of the electrical conductor is increased only in a portion existing outside the small-diameter portion 162 of the large-diameter portion 161 in a plan view, and the heat capacity of the electrical conductor is increased by the increase in the volume. That is, in comparison with the first case, this portion acts as a heat dissipation promoting portion at the time of resistance welding, such that heat is easily released from the inside of the electrical conductor, heat is less likely to be accumulated in the electrical conductor, and heat is less likely to be transferred from the electrical conductor to the periphery of the through-hole 121a.

On the other hand, in a case where resistance welding is performed by applying a current to the entire contact surface between the electrical conductor and the positive electrode lead foil 111a and the entire contact surface between the electrical conductor and the negative electrode lead foil 112a by using an electrical conductor made of a cylindrical body having the same diameter as that of the large-diameter portion 161 and the same dimension as that of the electrical conductor 160 in the axial direction (second case), the entire surface of the electrical conductor on the positive electrode lead foil 111a and the entire surface of the electrical conductor on the negative electrode lead foil 112a are melted to form a connection surface.

In comparison with the second case, because the bipolar lead-acid storage battery 100 of the embodiment has a smaller area of the electrical conductor to be melted and used as a connection surface, the amount of heat generated at the time of resistance welding is reduced. As a result, the amount of heat transferred to the electrical conductor is reduced, such that heat is less likely to be accumulated in the electrical conductor, and heat is less likely to be transferred from the electrical conductor to the periphery of the through-hole 121a.

As described above, in the bipolar lead-acid storage battery 100 of the embodiment, because the electrical conductor 160 satisfies S1>S2, as compared with the case of S1=S2 (the first case and the second case), it is possible to prevent the resin substrate 121 from having a high temperature and heat from being accumulated in the electrical conductor 160, such that it is possible to prevent deterioration of battery performance and occurrence of corrosion caused by gas accumulation.

In addition, in the bipolar lead-acid storage battery 100 of the embodiment, the ratio (S2/S1) of the area S2 of the connection surface 162a to the cross-sectional area S1 of the large-diameter portion 161 is 0.01 or more and 0.50 or less, such that the thermal performance (performance that heat is less likely to be accumulated in the electrical conductor and heat is less likely to be transferred from the electrical conductor to the periphery of the through-hole) at the time of resistance welding is particularly enhanced, and the conductive performance is also improved.

The ratio (S2/S1) is preferably small in terms of thermal performance at the time of resistance welding, but when the ratio (S2/S1) is too small, it is disadvantageous in terms of conductive performance. From the viewpoint of achieving both thermal performance and conductive performance at the time of resistance welding, the ratio (S2/S1) is preferably 0.01 or more and 0.50 or less.

Difference Between Embodiment and One Aspect of Present Invention

In the embodiment, both end portions of the electrical conductor 160 are small-diameter portions 162 (end portions having a connection surface having an area smaller than the cross-sectional area of the middle portion), but only one end portion may be a small-diameter portion 162. In addition, the diameter of the small-diameter portion 162 may decrease from the large-diameter portion 161 toward the contact surface, or the electrical conductor may have a shape in which the diameter decreases from one contact surface toward the other contact surface. In a case where the electrical conductor has a shape in which the diameter decreases from one contact surface toward the other contact surface, the cross-sectional area parallel to the connection surface of the middle portion is the cross-sectional area at the central position in the plate thickness direction of the substrate.

Furthermore, in the embodiment, in order to facilitate insertion of the electrical conductor 160 into the through-hole 121a of the substrate 121, the diameter of the middle portion 161 of the electrical conductor 160 is set to be slightly smaller than the diameter of the through-hole 121a. However, the diameter of the middle portion 161 of the electrical conductor 160 may be set to be smaller than the diameter of the through-hole 121a to provide a clear gap between the middle portion 161 and the through-hole 121a.

In addition, in the embodiment, the electrical conductor 160 is composed of the large-diameter portion 161 and the small-diameter portion 162, and the entire surface of the electrical contact surface of the small-diameter portion 162 with the positive electrode lead foil 111a and the negative electrode lead foil 112a is the connection surface. However, the electrical conductor may be a cylindrical member having a single diameter, and a part of the contact surface of the electrical conductor with the positive electrode lead foil 111a and the negative electrode lead foil 112a may be the connection surface. In this case, the spaces 181 and 182 are not formed.

In the embodiment, although the bipolar lead-acid storage battery in which the positive electrode current collector plate is formed of the positive electrode lead foil 111a and the negative electrode current collector plate is formed of the negative electrode lead foil 112a has been described, one aspect of the present invention can also be applied to a bipolar storage battery in which a positive electrode current collector plate and a negative electrode current collector plate are formed of a metal other than lead (for example, aluminum, copper, or nickel), an alloy, or a conductive resin.

The following is a list of reference signs used in this specification and in the drawings.
12 Recess of frame body
12e Non-flat bottom surface of recess
12f Surface along step
12g First bottom surface
12h Second bottom surface
13 Wall portion that partitions recesses adjacent to each other
14 First plate portion
15 Second plate portion
16 Leg portion
17 Reinforcing portion
100 Bipolar lead-acid storage battery
110 Cell member
111 Positive electrode
112 Negative electrode
111a Positive electrode lead foil (positive electrode current collector plate)
112a Negative electrode lead foil (negative electrode current collector plate)
111b Positive active material layer
112b Negative active material layer
113 Separator
120 Biplate
121 Substrate of biplate
121a Through-hole of substrate
121b First recess of substrate
121c Second recess of substrate
122 Frame body of biplate
130 First end plate
131 Substrate of first end plate
132 Frame body of first end plate
140 Second end plate
141 Substrate of second end plate
142 Frame body of second end plate
144a, 144b Non-contact surface
144 Surface of first plate portion (the other facing surface)
150 Adhesive layer
160 Electrical conductor
161 Large-diameter portion (middle portion) of electrical conductor
162 Small-diameter portion (end portion formed to be small) of electrical conductor
162a Connection surface of small-diameter portion
164 Surface of leg portion (one facing surface)
170 Cover plate
C Cell (space housing cell member)
E Line indicating position of surface along step in Z direction

What is claimed is:

1. A bipolar storage battery comprising:
a plurality of cell members each including a positive electrode including a positive electrode current collector plate and a positive active material layer, a negative electrode including a negative electrode current collector plate and a negative active material layer, and a separator interposed between the positive electrode and the negative electrode, the plurality of cell members being arranged in a stack manner with intervals; and
a plurality of space forming members each forming a plurality of spaces for individually housing the plurality of cell members,
wherein the space forming member includes a substrate that covers at least one of a side the positive electrode and a side of the negative electrode of the cell member, and a frame body that surrounds a side surface of the cell member,
the cell member and the substrate of the space forming member are arranged to be alternately stacked,
the frame bodies are joined to each other,
the substrate arranged between the cell members has a through-hole extending in a direction intersecting with a plate surface,
the positive electrode current collector plate and the negative electrode current collector plate of the cell members adjacent to each other are electrically connected to each other by an electrical conductor arranged in the through-hole, and the plurality of cell members are electrically connected in series, and
an area of at least one of a connection surface of the electrical conductor with the positive electrode current collector plate and a connection surface of the electrical conductor with the negative electrode current collector plate is smaller than a cross-sectional area of the electrical conductor parallel to the connection surface in a middle portion in a plate thickness direction of the substrate.

2. The bipolar storage battery according to claim 1, wherein a ratio (S2/S1) of an area S2 of the connection surface that is smaller than the cross-sectional area in the middle portion to the cross-sectional area S1 in the middle portion is 0.01 or more and 0.50 or less.

3. The bipolar storage battery according to claim 2, wherein the positive electrode current collector plate is formed of a positive electrode lead foil, and the negative electrode current collector plate is formed of a negative electrode lead foil.

4. The bipolar storage battery according to claim 1, wherein the positive electrode current collector plate is formed of a positive electrode lead foil, and the negative electrode current collector plate is formed of a negative electrode lead foil.
